(19) United States
(12) Patent Application Publication
(10) Pub. No.: US 2018/0198128 A1
(43) Pub. Date: Jul. 12, 2018

(54) FLUORINATED-POLYMER COATED ELECTRODES

(71) Applicant: South Dakota Board of Regents, Pierre, SD (US)

(72) Inventor: Haoran SUN, Vermillion, SD (US)

(73) Assignee: South Dakota Board of Regents, Pierre, SD (US)

(21) Appl. No.: 15/869,820

(22) Filed: Jan. 12, 2018

Related U.S. Application Data
(60) Provisional application No. 62/445,418, filed on Jan. 12, 2017.
(60) Provisional application No. 62/540,418, filed on Aug. 2, 2017.

(51) Int. Cl. H01M 4/62; H01M 4/131; H01M 4/58

(52) U.S. Cl. CPC H01M 4/623; H01M 2004/028; H01M 4/5825; H01M 4/131

(57) ABSTRACT

Discovering high capacity and high rate cathodic materials is of paramount importance for the further development of electrochemical energy storage devices. Reported herein is a perfluoroalkylated polymer, integrated with an electronically-conductive backbone and an electron transfer catalyst unit that can serve as a new type of cathodic material reaching practical specific capacity of 919 mAh/g at 2.5 C discharging rate and over 700 mAh/g at 16 C discharging rate. A prepolarization treatment of the cathodic materials further increases working voltage to over 2.1 V versus Li/Li⁺ in classical PC/LiPF₆ electrolyte solution giving maximum specific capacity of 1028 mAh/g and specific energy of 2159 mWh/g.

### RELATED APPLICATIONS

This application claims priority under 35 U.S.C. § 119(e) to U.S. Provisional Patent Application Nos. 62/445,418, filed Jan. 12, 2017, and 62/540,418, filed Aug. 2, 2017 both of which are incorporated herein by reference.

### GOVERNMENT SUPPORT

This invention was made with government support under Grant No. CHE1355677 awarded by the National Science Foundation, and by NASA grant number NNX14AN22A. The government has certain rights in the invention.

### BACKGROUND OF THE INVENTION

Low specific capacity and low charge/discharge rate of current cathodic materials are the bottle-neck for the next generation electrochemical energy storage devices, particularly for “on-demand applications”. Transition metal salts (e.g. LiMO₂, LiMPO₄, and mixed metal oxide lithium salts) are commonly used as cathodic materials for current batteries. The heavy nature of these transition metal elements limits their capacity below 300 mAh/g. Fluorinated carbon, CFₓ (0<x<1.3, with most cases x≤1.0), has been the main component of primary lithium batteries since the 1970s. The high capacity cathodic material suffers from low conductivity and slow electron transfer kinetics caused by the large activation barrier of breaking the strong C—F bond (BDE=128 kcal/mol); this results in a low discharging rate. Furthermore, preparation of CFₓ materials, obtained from direct fluorination of graphite with F₂ gas at high temperature (300-600° C.), results in large variation and the challenge of product quality control as well as a significant safety threat associated with production of the materials. Though recent approaches to modification of carbon nanotube-based CFₓ materials have improved the rate capacity, the natural low loading capacity of these nanomaterials and requirement of addition of conducting materials (e.g. carbon black) and mechanical binding materials (e.g. PVDF) limits its practical application where large loading capacity is required.

High capacity cathodic materials are of paramount importance for the further development of electrochemical energy storage devices. Accordingly, high capacity batteries from fluorinated binder-free conductive polymeric cathodes can provide a solution.

### SUMMARY

A new type of fluorinated carbon material was designed to comprise an electronically-conducting polymer backbone, an aromatic-based electron-transfer catalyst unit, and an energy storage unit (perfluoroalkyl chains) yet still maintains the composition of CFₓ to keep the high specific capacity (Scheme A). To do so, this disclosure utilizes 1) an aniline, and/or thiophene, and/or pyrrole substituent to form the electronically-conducting backbone by electrochemical polymerization or chemical polymerization; 2) an electron-poor aromatic core; and 3) perfluoroalkyl chains.

Accordingly, this disclosure provides a conductive fluoropolymer comprising Formula I:

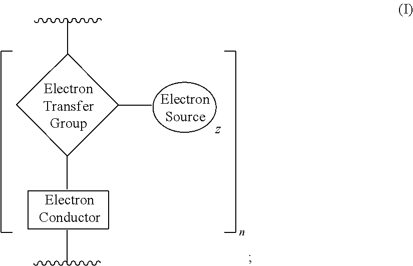

wherein

Electron Source (ES) is a fluorocarbon substituent, or a fluorocarbon substituent comprising a polyene, polyyne, or a polyene and polyyne;

Electron Transfer Group (ET) is an electron withdrawing polycyclic aromatic group covalently bonded to ES, and ET is optionally substituted with one or more electron withdrawing groups;

Electron Conductor (EC) is an electron conducting bisaromatic or trisaromatic moiety conjugated to ET;

n is greater than 1, and Formula I is conjugated to at least one additional Formula I through an EC to ET bond; and

z is 1-20;

wherein the conductive fluoropolymer stores energy in the Electron Source as carbon-fluorine bonds.

This disclosure also provides a cathode coated with the disclosed conductive fluoropolymer, wherein the energy in the carbon-fluorine bonds of the Electron Source is capable of being released as electrons to the Electron Transfer Group wherein the electrons are transmitted by the Electron Conductor from the coated cathode.

Additionally, this disclosure provides a method of producing electrochemical energy from a high capacity electrochemical cell, comprising:

discharging a high capacity electrochemical cell wherein fluoride is released from a conductive fluoropolymer described herein, thereby producing electrochemical energy, and wherein the high capacity electrochemical cell comprises:

a) a positive electrode coated with the conductive fluoropolymer;

b) a negative electrode hosting an alkali metal or alloy of alkali metals; and

c) an ion porous membrane disposed between the positive and negative electrode;

wherein the positive and negative electrodes and the membrane are immersed in an electrolyte.

The disclosure also provides novel conductive fluoropolymers of Formulas I-VII, intermediates for the synthesis of conductive fluoropolymers of Formulas I-VII, as well as methods of preparing conductive fluoropolymers of Formulas I-VII. The disclosure also provides monomers of Formulas I-VII that are useful as intermediates for the synthesis of other useful monomers and compounds. The disclosure provides for the use of conductive fluoropolymers of Formulas I-VII and for the manufacture of conductive fluoropolymers of Formulas I-VII.

### Scheme A.

General formula of binder-free fluorinated conductive polymeric cathodes and corresponding monomers.

HR¹—Ar—R²Hₙ

H—R¹—Ar—R²—H

wherein R¹=aniline or pyrrole or thiophene and its derivatives; R²=aniline or pyrrole or thiophene and its derivatives; and R¹ and R² can be the same or different; n is greater than 1; and Ar is perfluoroalkylated polyaromatic which contains an aromatic core with long perfluoroalkyl chain with formula of CₘF₂ₘ₊₁, wherein m is integral of 2-1000.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A-1E. Cyclic voltammogram of M-1 (a-d) in DFB/0.1 M TBAPF₆. Pt WE (ø 1.0 mm), Pt CE, and Ag/AgCl RE, potential sweep rate 100 mV/s. a) without Fc; b) and c) with Fc as internal standard; d) repetitive potential scan (0->−1.3->1.8->0, 10 cycles). e) Cyclic voltammogram of P-1 on Pt WE in DFB/0.1 M TBAPF₆ at various potential scan rate.

FIG. 1F. Conceptual design of CFₓ cathodic materials with fast rate capacity.

FIG. 2A-2B. Cyclic voltammogram of P-1 on Pt WE in DFB/0.2 M TBAPF₆ with Fc, 100 mV/s, (a) 0->0.6->−1.25->0 and (b) 0->−2.4->0.6->0.

FIG. 3A. Constant current discharge profile of P-1 on Pt WE in DFB/0.2 M TBAPF₆ with Pt CE and Ag/AgCl RE.

FIG. 3B. Constant current discharge of P-1 on glassy carbon (GC) WE in PC/1.0 M LIPF₆ with two pieces of Li foil as CE and RE respectively. Line (triangle), pre-discharge and charge treatment of the P-1 GC electrode, line (diamond), complete discharge after pretreatment.

FIG. 4. SEM image of polymer P-1 on ITO working electrode.

FIG. 5. Electrochemical polymerization of A-1 by cyclic voltammetry in DFB/0.1 M TBAPF₆. GC WE, Pt CE, and Ag/AgCl RE, potential sweep rate 100 mV/s.

FIG. 6A and FIG. 6B. Cyclic voltammogram (6A) and corresponding plot of peak current vs. potential scan rates (6B) of conducting polymer made from A-1 in DFB/0.1 M TBAPF₆. GC WE, Pt CE, Ag/AgCl RE.

FIG. 7. SEM image of polymer made from A-1 on ITO working electrode. Light gray area: ITO glass.

FIG. 8. Constant current discharge behavior of fluorinated polymer made from monomer A-1 in DFB with 0.1 M TBAPF₆. GC WE, Pt CE, Ag/AgCl RE.

FIG. 9. Cyclic voltammogram perfluoroalkylated dibenzo[a,c]phenazine in DFB 0.2 M TBAPF₆, Pt disk working electrode, at 100 mV/s. shown here background CV (lowest current curve), CV from 0->−1.25->1.8-0, and CV 0->−2.5->−2.1->0.

FIG. 10. Cyclic voltammogram of perfluoroalkylated dibenzo[a,c]phenazine in DFB 0.2 M TBAPF₆, Pt disk working electrode, at 10 mV/s. shown here CV from 0->−1.25->1.8-0, and CV 0->−2.4->1.8->0.

FIG. 11. Cyclic voltammogram stability of polymer P-1 on Pt electrode in clean DFB 0.2 M TBAPF₆, Pt disk working electrode, at 100 mV/s, 0->−1.3->1.8->0 (1st cycle and 101st cycle).

FIG. 12. Electrochemical polymerization of M-2 on Pt electrode in DFB/0.1 M TBAPF₆, 100 mV/s, 30 cycles.

FIG. 13. Electrochemistry of P-2 in DFB/0.1 M TBAPF₆, 100 mV/s, lower current one is the solvent background.

FIG. 14. Additional SEM image of P-1 on ITO glass.

FIG. 15. Additional SEM image of P-1 on ITO glass (side view) black section is the ITO layer.

FIG. 16. Diagram of a battery.

### DETAILED DESCRIPTION

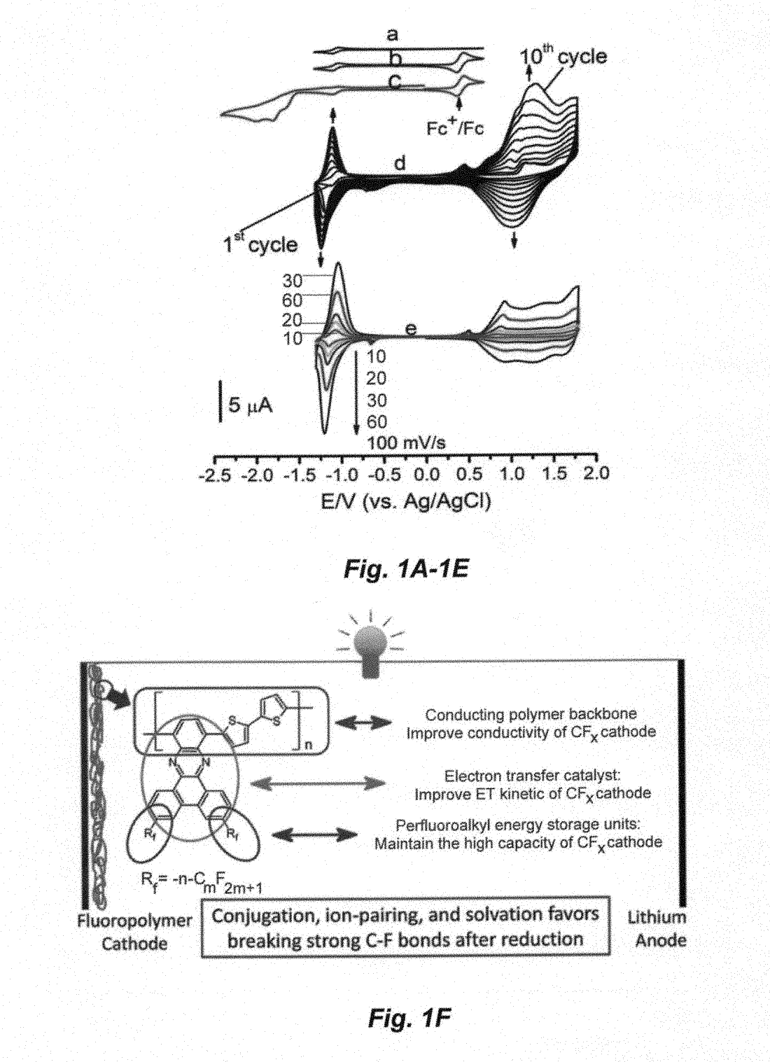

To solve this low conductivity and low discharge rate problem for CFₓ-based cathodic materials, a new type of fluorinated carbon material was designed to comprise an electronically-conducting polymer backbone, an aromatic-based electron-transfer catalyst unit, and an energy storage unit (perfluoroalkyl chains), but still maintains the composition of CFₓ to keep the high specific capacity (FIG. 1F). This disclosure utilizes 1) a thiophene unit as the electronically-conducting monomer unit to form the electronically-conducting backbone by electrochemical polymerization or oxidative chemical polymerization; 2) an electron poor nitrogen-containing dibenzophenazine core as the electron transfer (ET) catalytic center; and 3) long perfluoroalkyl chains as the energy storage units that are directly connected to the ET catalytic center through covalent bonds to facilitate rapid ET reaction. The electron poor aromatic core possesses higher reduction potential compared to electron rich ones, providing higher voltage when assembled into a full battery cell.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the end-points of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%. For example, repeat unit A is substantially soluble (e.g., greater than about 95% or greater than about 99%) in a polar organic solvent and is substantially insoluble (e.g., less than about 5% or less than about 1%) in a fluorocarbon solvent. In another example, repeat unit B is substantially soluble (e.g., greater than about 95% or greater than about 99%) in a fluorocarbon solvent and is substantially insoluble (e.g., less than about 5% or less than about 1%) in a polar organic solvent.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

Further examples of useful organic solvents include any organic solvent in which the starting materials and reagents are sufficiently soluble to provide reaction products. Examples of such organic solvents may include ketones such as cyclohexanone and methyl amyl ketone; alcohols such as 3-methoxybutanol, 3-methyl-3-methoxybutanol, 1-methoxy-2-propanol, and 1-ethoxy-2-propanol; ethers such as propylenegylcol monomethyl ether, ethylenegylcol monomethyl ether, propylenegylcol monoethyl ether, ethylenegylcol monoethyl ether, propylenegylcol dimethyl ether, and diethyleneglycol dimethyl ether; esters such as propylenegylcol monomethyl ether acetate, propylenegylcol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylenegylcol mono-tert-butyl ether acetate; and lactones such as y-butyrolactone. These organic solvents may be used alone or in a mixture of two or more kinds thereof, but are not limited thereto.

As used herein, the term “substituted” or “substituent” is intended to indicate that one or more (for example, 1-20 in various embodiments, 1-10 in other embodiments, 1, 2, 3, 4, or 5; in some embodiments 1, 2, or 3; and in other embodiments 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, halo, haloalkyl, hydroxy, hydroxyalkyl, aryl, heteroaryl, heterocycle, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfinyl, alkylsulfonyl, and cyano. Additionally, the suitable indicated groups can include, e.g., —X, —R, —O⁻, —OR, —SR, —S⁻, —NR₂, —NR₃, ═NR, —CX₃, —CN, —OCN, —SCN, —N═C═O, —NCS, —NO, —NO₂, ═N₂, —N₃, NC(═O)R, —C(═O)R, —C(═O)NRR—S(═O)₂O⁻, —S(═O)₂OH, —S(═O)₂R, —OS(═O)₂OR, —S(═O)₂NR, —S(═O)R, —OP(═O)O₂RR, —P(═O)O₂RR—P(═O)(O−)₂, —P(═O)(OH)₂, —C(═O)R, —C(═O)X, —C(S)R, —C(O)OR, —C(O)O⁻, —C(S)OR, —C(O)SR, —C(S)SR, —C(O)NRR, —C(S)NRR, —C(NR)NRR, where each X is independently a halogen (“halo”): F, Cl, Br, or I; and each R is independently H, alkyl, aryl, heterocycle, protecting group or prodrug moiety. As would be readily understood by one skilled in the art, when a substituent is keto (i.e., ═O) or thioxo (i.e., ═S), or the like, then two hydrogen atoms on the substituted atom are replaced. Another example of a substituent is a fluorocarbon that refers to any organic moiety, preferably less than 1000 daltons, having more than one fluoro substituent such as a perfluoroalkyl, perfluoroaryl, or perfluoroheteroaryl. Said fluorocarbon substituent may have some hydrogen substituents replaced with fluoro or all hydrogens replaced with fluoro. In some embodiments, the fluorocarbon may be more than about 1000 daltons. In yet other embodiments the fluorocarbon is about 1000 daltons to about 10,000 daltons.

The term “alkyl” refers to a branched or unbranched hydrocarbon having, for example, from 1-20 carbon atoms, and often 1-12, 1-10, 1-8, 1-6, or 1-4 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below. The alkyl can also be optionally partially or fully unsaturated. As such, the recitation of an alkyl group can include both alkenyl and alkynyl groups. The alkyl can be a monovalent hydrocarbon radical, as described and exemplified above, or it can be a divalent hydrocarbon radical (i.e., an alkylene).

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “aromatic” refers to either an aryl or heteroaryl group or substituent described herein. Additionally, an aromatic moiety may be a bisaromatic moiety, a trisaromatic moiety, and so on. A bisaromatic moiety has a single bond between two aromatic moieties such as, but not limited to, biphenyl, or bipyridine. Similarly, a trisaromatic moiety has a single bond between each aromatic moiety.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. In other embodiments, the aryl group can have 6 to 60 carbons atoms, 6 to 120 carbon atoms, or 6 to 240 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms. Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

The phrase “one or more” is readily understood by one of skill in the art, particularly when read in context of its usage. For example, one or more substituents on a phenyl ring refers to one to five, or one to up to four, for example if the phenyl ring is disubstituted. One or more subunits (i.e., repeat units or blocks) of a polymer can refer to about 5 to about 500,000,000 or any number of subunits to obtain an aspect ratio of about 10⁴ to about 10²⁰.

Substituents of the compounds and polymers described herein may be present to a recursive degree. In this context, “recursive substituent” means that a substituent may recite another instance of itself. Because of the recursive nature of such substituents, theoretically, a large number may be present in any given claim. One of ordinary skill in the art of organic chemistry understands that the total number of such substituents is reasonably limited by the desired properties of the compound intended. Such properties include, by of example and not limitation, physical properties such as molecular weight, solubility or log P, application properties such as activity against the intended target, and practical properties such as ease of synthesis. Recursive substituents are an intended aspect of the invention. One of ordinary skill in the art of organic chemistry understands the versatility of such substituents. To the degree that recursive substituents are present in a claim of the invention, the total number in the repeating unit of a polymer example can be, for example, about 1-50, about 1-40, about 1-30, about 1-20, about 1-10, or about 1-5.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer film or monolayer.

In this disclosure, the symbol “C” refers to the discharge rate. In describing batteries, discharge current is often expressed as a C-rate in order to normalize against battery capacity, which is often very different between batteries. A C-rate is a measure of the rate at which a battery is discharged relative to its maximum capacity. A 1 C rate means that the discharge current will discharge the entire battery in 1 hour. For a battery with a capacity of 100 Amp-hrs, this equates to a discharge current of 100 Amps. A 5 C rate for this battery would be 500 Amps, and a C/2 rate would be 50 Amps.

### Embodiments of the Invention

This disclosure describes various embodiments of a conductive fluoropolymer comprising Formula I:

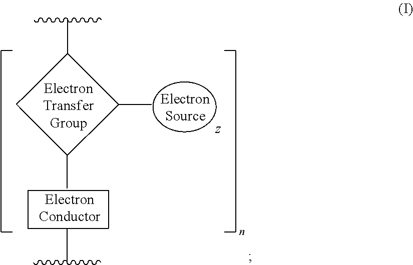

wherein
Electron Source (ES) is a fluorocarbon substituent, or a fluorocarbon substituent comprising a polyene, polyyne, or a polyene and polyyne;
Electron Transfer Group (ET) is an electron withdrawing (or an electron poor) polycyclic aromatic group covalently bonded to ES, and ET is optionally substituted with one or more electron withdrawing groups;
Electron Conductor (EC) is an electron conducting bisaromatic or trisaromatic moiety conjugated to ET;
n is greater than 1, and Formula I is conjugated to at least one additional Formula I through an EC to ET bond; and
z is 1-20;
wherein the conductive fluoropolymer stores energy in the Electron Source as carbon-fluorine bonds.

It is noted that in FIG. 1F, the conducting polymer backbone corresponds to EC, the electron transfer catalyst corresponds to ET, and the energy storage unit corresponds to ES. Also, ES in Formula I corresponds to X in various embodiments of Formulas II to VII. In some embodiments, z is 1, 2, 3, 4, or 5, z is 1-10, z is 1-50, or z is 1-100. In Formula I, ES can be considered as X, and there can be up to about 100 of X (e.g., X_{z}). In additional embodiments, ES is conjugated to ET. In other additional embodiments, ET is conjugated to EC. In some embodiments, the bond between ES and ET, or ET and EC is a single bond, a double bond, or a triple bond.

In other embodiments, the fluorocarbon substituent is an alkyl, polyvinyl or polyaryl substituent, wherein the alkyl, polyvinyl or polyaryl substituent comprises 2 or more fluorine substituents. In additional embodiments, the fluorocarbon substituent is —CₘF₂ₘ₊₁ and m is greater than zero. In some other embodiments, the fluorocarbon substituent is —C₄F₉, —C₆F₁₃, —C₈F₁₇, or —C₁₂F₂₅. In yet other embodiments the fluorocarbon can vary in the number of carbons and fluoros from —C₄F₉ to —C₁₂F₂₅. In additional embodiments, the fluorocarbon substituent can be linear, branched, or isomers of —C₄F₉ to —C₁₂F₂₅.

In various other embodiments, the polycyclic aromatic group comprises a polyaryl hydrocarbon or a heteroatom-containing polyaryl hydrocarbon. In some embodiments, the polycyclic aromatic group comprises a pyrene, naphthalene, anthracene, coronene, phenazine, phenanthroline, phthalocyanine, quinoxaline, quinoline, porphyrin, benzoporphyrin, quinazoline, benzofuran, indole, benzoxazole, or benzimidazole. In other embodiments, the polycyclic aromatic group is substituted with one or more electron withdrawing groups. In yet other embodiments, the electron withdrawing group is halo, cyano, nitro, carboxyl, sulfonyl, phosphoryl, aryl, pyridine, or pyridine N-oxide. In yet other embodiments, the heteroatom-containing polyaryl hydrocarbon is a transition metal complex.

In other various embodiments, the transition metal complex is a metallophthalocyanine, metalloporphyrin, or metallobenzoporphyrin. In additional embodiments, ET has a first reduction potential equal to about 0.5 V or above about 0.5 V versus a Li⁺/Li electrode and a first oxidation potential equal to about 6 V or less than about 6 V versus the Li⁺/Li electrode. In some additional embodiments, ET has the first reduction potential equal or above about 0.1 V vs. Li⁺/Li electrode and first oxidation potential equal or less than about 10 V vs. Li⁺/Li electrode.

In yet other various embodiments, the bisaromatic or trisaromatic moiety comprises a thiophene, pyrrole, aniline, or a combination thereof, wherein said moieties have optional substituents.

This disclosure also provides various embodiments of a conductive fluoropolymer wherein Formula I is Formula II:

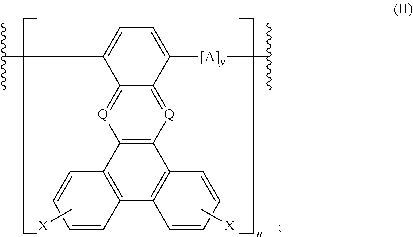

wherein
each X is independently a fluorocarbon, or a fluorocarbon comprising a polyene, polyyne, or both;
each Q is independently CR¹ or N, wherein each R¹ is independently H, halo, CN, NO₂, COR², or SO₂R², and each R² is independently H, OH, alkoxy, or alkyl;
each A is independently thiophene, pyrrole, aniline, benzothiophene, or indole;
y is 2, 3, or 4; and
n is >20.

In additional embodiments, y is greater than 2, y is greater than 3, y is greater than 4, y is 2-20. y is 2-10, y is 2-5, or y is 2, 3, 4, 5, 6, 7, 8, 9, or 10. In some embodiments disclosed herein, n is 1. In other embodiments, n is greater than 1. In various embodiments n is less than about 20, or n is about 20 to about 10¹⁰. In other embodiments, n is less than about 10⁹, 10⁸, 10⁷, 10⁶, 10⁵, 10⁴, or 10³. In some embodiments, X is —CₘF₂ₘ₊₁ and m is greater than zero. In other embodiments, Formula II is Formula III:

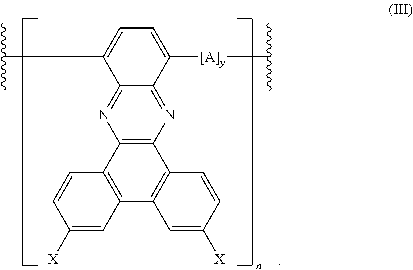

In yet additional embodiments, Formula III is one of Formulas IV-VI:

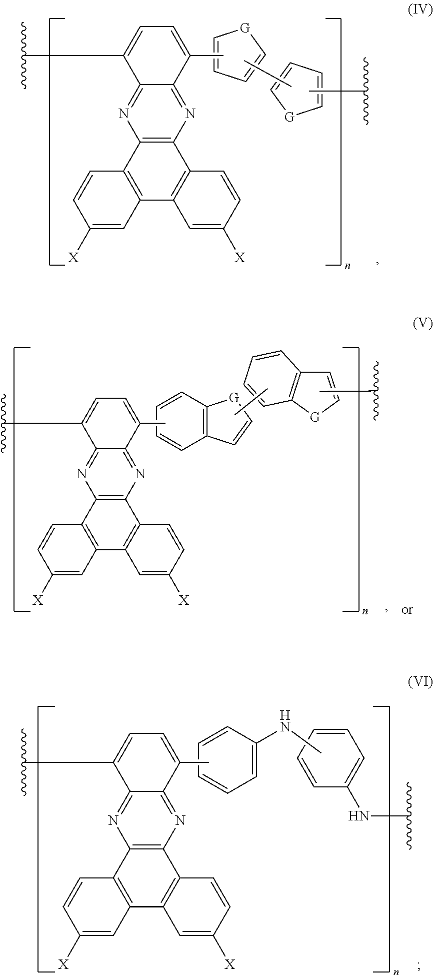

wherein
each G is independently S or NH. It is noted that the shown floating bond to the heterocycle can be attached to any position on the 5- or 6-membered ring to which it is directed, thereby indicating a regioisomer in part.

In yet other embodiments, Formula IV is Formula VII:

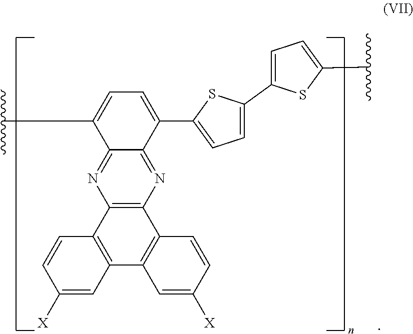

This disclosure also provides various embodiments of a cathode coated with the conductive fluoropolymer disclosed herein, wherein the energy in the carbon-fluorine bonds of the Electron Source is capable of being released as electrons to the Electron Transfer Group wherein the electrons are transmitted to a current collector by the Electron Conductor from the coated cathode. In some embodiments the current collector comprises aluminum, platinum, iridium, copper, silicon, or carbon.

This disclosure also provides various embodiments of a method of producing electrochemical energy from a high capacity electrochemical cell, comprising:
discharging a high capacity electrochemical cell wherein fluoride is released from a conductive fluoropolymer disclosed herein, thereby producing electrochemical energy, and wherein the high capacity electrochemical cell comprises:
   a) a positive electrode coated with the conductive fluoropolymer;
   b) a negative electrode hosting an alkali metal or alloy of alkali metals; and
   c) an ion porous membrane disposed between the positive and negative electrode;

wherein the positive and negative electrodes and the membrane are immersed in an electrolyte.

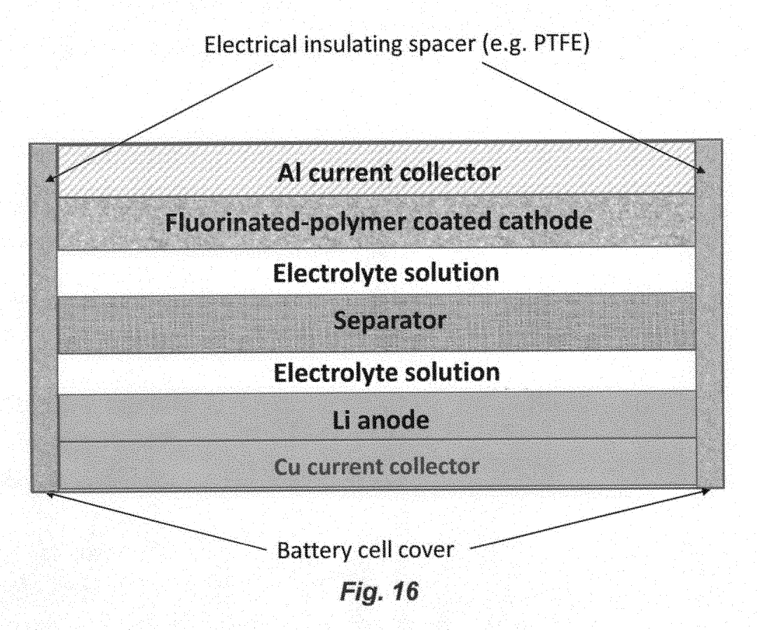

In additional embodiments, the electrochemical cell or battery comprises a current collector (for example aluminum and/or copper), a cathode coated with a fluorinated polymer disclosed herein, an electrolyte solution and separator such as those known to a person of ordinary skill in the art (see FIG. 16). In various embodiments, the positive electrode or a cathode coated with the conductive fluoropolymer has a specific capacity of at least about 500 mAh/g at about 2.5 C. In additional embodiments, a prepolarizing step of the positive electrode or the cathode increases the specific capacity. In yet other embodiments, the specific capacity increases to at least about 1000 mAh/g. In other embodiments the specific capacity increases to at least about 250 mAh/g, 750 mAh/g, 1250 mAh/g, 1500 mAh/g, 1750 mAh/g, or 2000 mAh/g. In some embodiments, the maximum specific capacity increase is about 3500 mAh/g. In yet other embodiments, the specific energy is about 500 mWh/g to about 8000 mWh/g, or about 1500 mWh/g to about 4000 mWh/g.

Various embodiments in this disclosure provide a fluorinated polymer comprising a conducting backbone, electron transfer catalyst, and fluorinated substituents, wherein the electron transfer catalyst unit is an aromatic ring with at least two conjugate double bonds, wherein the fluorinated substituents can be fluorinated aromatics, straight chain conjugated vinyl units, and perfluoroalkyl units.

In other embodiments, said electron transfer catalyst aromatic comprises polyaromatic hydrocarbon (PAH) including but not limited to benzene, pyrene, naphthalene, anthracene, coronene, or heterocyclic aromatic compounds including but not limited to phenazine, phenanthroline, phthalocyanine and metallophthalocyanine, porphyrin and metalloporphyrin, benzoporphyrin and metallobenzoporphyrin.

In some embodiments, said fluorinated substituents compromise a perfluoroalkyl group having a formula of —(CF₂)ᵥCF₃ where v is 0-100. In other embodiments, said conducting polymer backbone comprises polythiophene, polypyrrole, polyaniline, and their derivatives. In yet other embodiments, said electron transfer catalyst comprises transition metal complexes with conjugated heteroaromatic ligands including but not limited to phenanthroline, phthalocyanine, porphyrin, and benzoporphyrin. In additional embodiments, conducting polymer backbone, electron transfer catalyst, and fluorinated substituent are covalently bonded through carbon-carbon bonds. In some other embodiments, said conducting polymer backbone and electron transfer catalyst are conjugated. In various embodiments, said fluorinated substituent directly connects to the electron transfer catalyst through covalent bonding. In other various embodiments, electron transfer catalyst has the first reduction potential equal or above 0.5 V vs. Li⁺/Li electrode and first oxidation potential equal or less than 6 V vs. Li⁺/Li electrode.

This disclosure includes embodiments of a method of making the disclosed fluorinated polymer comprising forming the fluorinated polymer electrochemically or chemically starting with a monomer unit containing thiophene, aniline, pyrrole, or their derivatives having at least one unsubstituted ring position that can form new carbon-carbon bonds during the polymerization processes. Other embodiments comprise electrochemical polymerization through oxidation processes of said fluorinated monomer or chemical polymerization through oxidation processes of said fluorinated polymer. Additional embodiments comprise electrochemical oxidation techniques, wherein said electrochemical oxidation techniques comprise repetitive potential sweeping between 0.5 V and 6 V vs. Li⁺/Li reference electrode, control potential electrolysis at potential equal or above 2.5 V vs. Li⁺/Li reference electrode, control current electrolysis. In some other embodiments repetitive potential sweeping is between about 0.1 V and about 10 V vs. Li⁺/Li reference electrode, or control potential electrolysis is at potential equal or above about 1 V vs. Li⁺/Li reference electrode, control current electrolysis.

Additional embodiments in this disclosure include methods of making said fluorinated polymer comprising bulk electrolysis cells with metal, metal alloy, carbon, porous carbon, or ITO working electrodes and metal alloy, carbon, porous carbon, or ITO counter electrodes. Some other embodiments comprise non-aqueous electrolyte solution, wherein said electrolyte solution comprises aprotic organic solvents and organic-soluble electrolytes, wherein said electrolytes are ammonium salts with cation formula of NR₄ in which R is a functional group with the formula —(CH₂)ₙH and n is an integral of 0-30, or phenyl and derivatives, phosphonium salts with the cation formula of PR₄ in which R is a functional group with the formula —(CH₂)ₙH and n is an integer of 0-30 or phenyl and derivatives, organic soluble metal salts with cations including but not limited to Li, Na, K, Rb, Mg, Ca, Ba, Al, Ga. Some other embodiments comprise aprotic organic solvents methylene chloride, THF, 1,2-difluorobenzene, trifluoromethyl-benzene, chlorobenzene, dichlorobenzene, trichlorobenzene, acetonitrile, acetone, chloroform, DMF, DMSO.

This disclosure also provides an electrochemical cell comprising: a positive electrode comprising said fluorinated polymer disclosed herein;

a negative electrode comprising alkali metal and alkali metal cation hosting materials, wherein said alkali metal is Li, Na, K, or an alloy of said alkali metals, wherein said alkali metal cation hosting material is porous carbon, graphite, graphene, or Si; and

an electrolyte between said positive electrode and said negative electrode wherein said electrolyte comprising an organic solvent or a mixture of organic solvents and alkali metal salts soluble in said organic solvents and is capable to conducting charged species;

wherein said positive electrode releases fluoride during the discharge process and further accepting lithium cation during the further discharge process of said electrochemical cell.

In various embodiments, said fluorinated polymer is a positive electrode, wherein said the positive electrode comprises metal, metal alloy, carbon, or conducting composite as a current collector. In other embodiments, said fluorinated polymer is a positive electrode in which a prepolarization treatment has been done by means of partially discharge and charge the positive electrode. Other embodiments of the disclosed electrochemical cell comprise a porous separator between positive and negative electrodes wherein said separator allows ion conducting and ion transport through it to reach the positive and negative electrode. Yet other embodiments comprise an electrolyte comprising an organic solvent or a mixture of organic solvents and alkali metal salts soluble in said organic solvents and is capable to conducting charged species.

This disclosure also includes methods of preparing monomers and polymers as shown in Schemes 1-4 and Schemes A-B.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described elsewhere in this disclosure.

### Results and Discussion

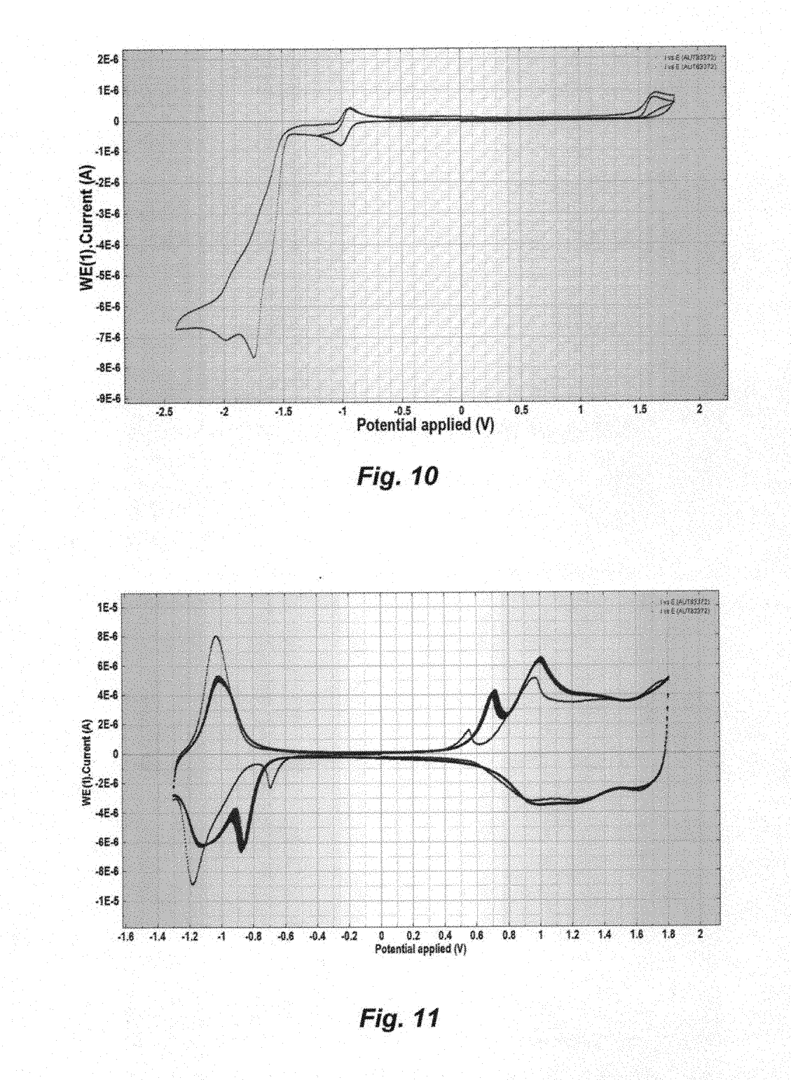

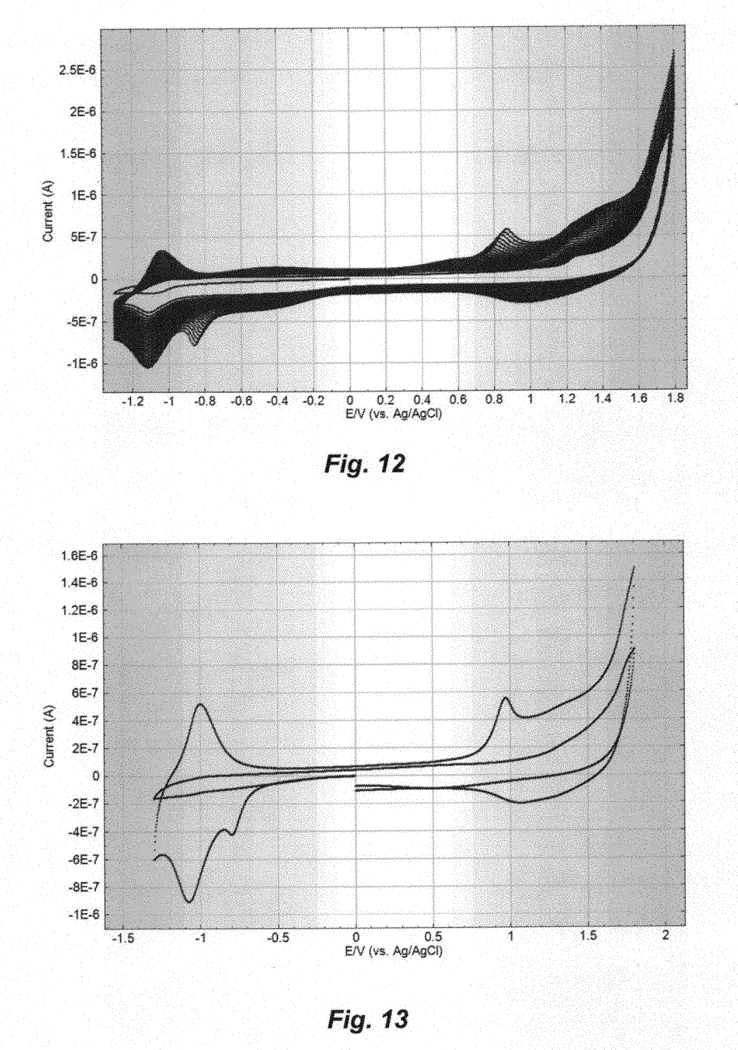

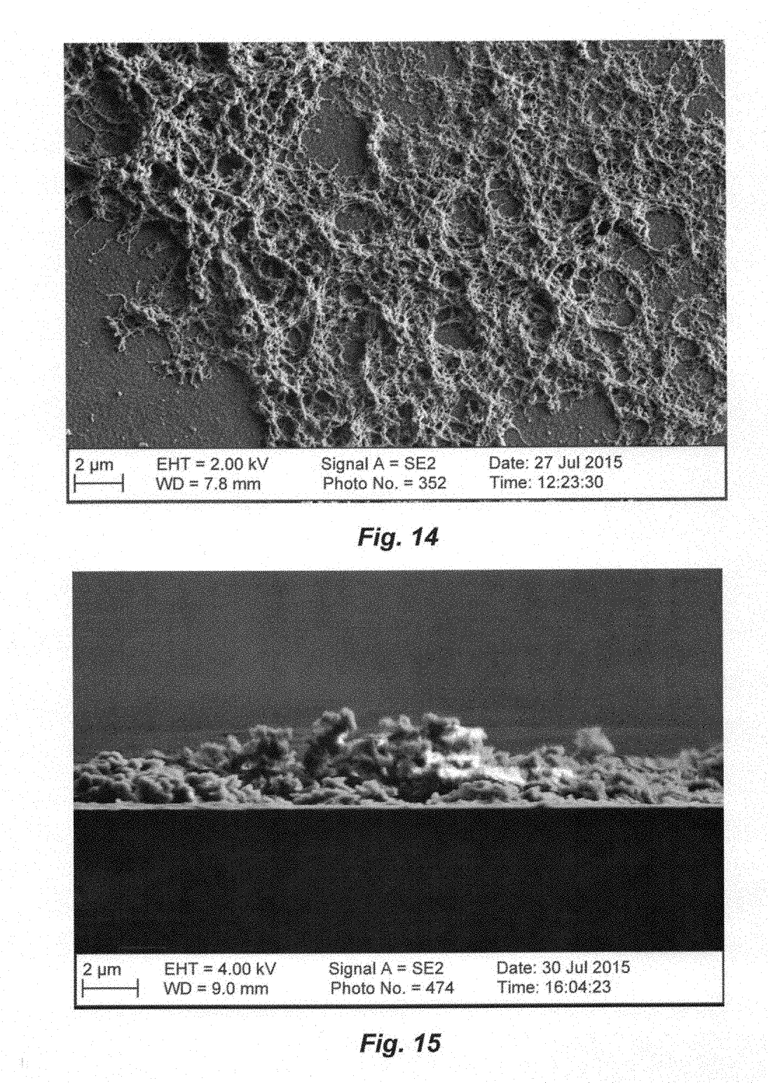

The target monomers M-1 and M-2 (Scheme 1) were synthesized through a condensation reaction involving bisthiophene-substituted analine diamine (Compound 2) and bisperfluoroalklated phenathrene diketone (Compound 3a or 3b) in good yield. Compound 2 was synthesized from compound 1 according to a reported procedure (J. Phys. Chem. B 2011, 115, 7923). The final monomeric products M-1 and M-2 were characterized by ¹H and ¹⁹F NMR, ESI-MS, and elemental analyses. The corresponding polymers (P-1 and P-2) were electrochemically synthesized onto Pt, or glassy carbon (GC), or tin-doped indium oxide (ITO), or aluminum (Al) working electrodes by repetitive cyclic voltammetry (via infra). The polymers were characterized by electrochemical, spectroscopic, and scanning electron microscopic (SEM) methods. All electrochemical experiments were done either in a N₂ or Ar filled glovebox with residual O₂ and water levels less than 1 ppm. Three electrode systems, either with Pt counter electrode and Ag/AgCl reference electrode or Li counter electrode and Li/Li⁺ reference electrode, were used for the characterization of polymeric cathodic materials on Pt or GC or Al in both 1,2-difluorobenzene (DFB)/TBAPF₆ and propylene carbonate (PC)/LiPF₆ solution. Integration of the current vs. time of the first reduction wave in the cycle voltammogram or the first constant current discharge curve gives us the total amount of polymer materials P-1 or P-2 on the electrode surface in terms of mol/cm² or g/cm² with respect to the polymer unit. Detailed experimental procedures and additional characterization data are given in the Examples and FIGS. 9-15.

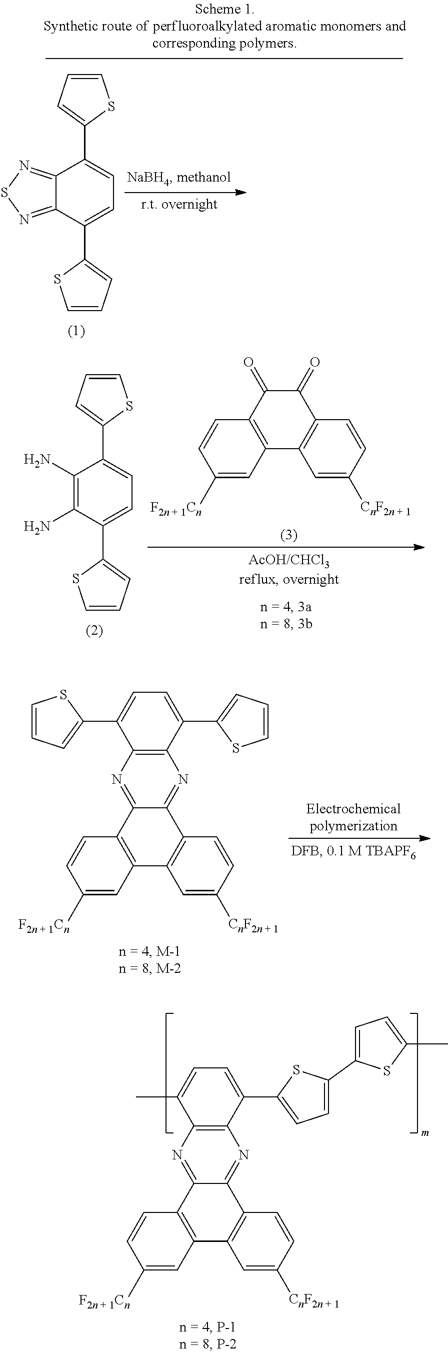

Both M-1 and M-2 show similar electrochemical behaviors in DFB with TBAPF₆ as the supporting electrolyte, though solubility of M-2 is lower than that of M-1 resulting in a lower current. M-1 and M-2 show quasi-reversible first reduction waves at E_{1/2}=−1.045 V and E_{1/2}=−1.025 V (vs. Ag/AgCl), respectively. Upon potential sweep to a further negative direction, a group of three overlapped irreversible reduction waves with much larger current is observed compared to the current of first reduction wave (FIG. 1A, 1B, 1C). Compared to the electrochemical results of perfluoroalklylated dibenzophenazine, one of these three overlapped reduction waves is likely caused by the second reduction of the dibenzophenazine core. The observed large reduction current is caused by the reductive defluorination of perfluoroalkyl chain (—C₄F₉ and —C₈F₁₇ for M-1 and M-2, respectively) which is consistent with literature reported results for the electrochemical reduction of perfluoroalkylated benzonitriles (J. Phys. Chem. B 2003, 107, 10894). Both monomers M-1 and M-2 show irreversible oxidation at E_{p/2}=1.136 V and E_{p/2}=1.212 V (vs. Ag/AgCl), respectively. This irreversible oxidation is due to the oxidation of thiopehene unit and followed by a polymerization reaction that is similar to the electrochemical polymerization processes of thiophene and its derivatives.

Repetitive potential sweeping between −1.3 V and 1.8 V for M-1 in DFB solution increased both cathodic and anodic currents as shown in FIG. 1D, clearly indicating the occurrence of electrochemical polymerization of M-1 on the working electrode surface. After 10 repetitive potential sweeping cycles, the potential scan was stopped at 0 V after the last vertex potential switched at 1.8 V resulting in a charge-neutral polymer film on the Pt or GC or Al electrode. This P-1 modified electrode was then placed in a DFB solution with 0.1 M TBAPF₆ as the supporting electrolyte. The polymer P-1 exhibits broad oxidation peaks due to the oxidation of polythiophene backbone and relative sharp reduction wave which is caused by the reduction of the dibenzophenazine ring. The peak current is linearly proportional to the potential sweep rate which indicates that this is surface redox behavior of a redox-active thin film (FIG. 1E). Continuous repetitive potential sweeping between −1.3 V and 1.8 V shows excellent stability of this thin film.

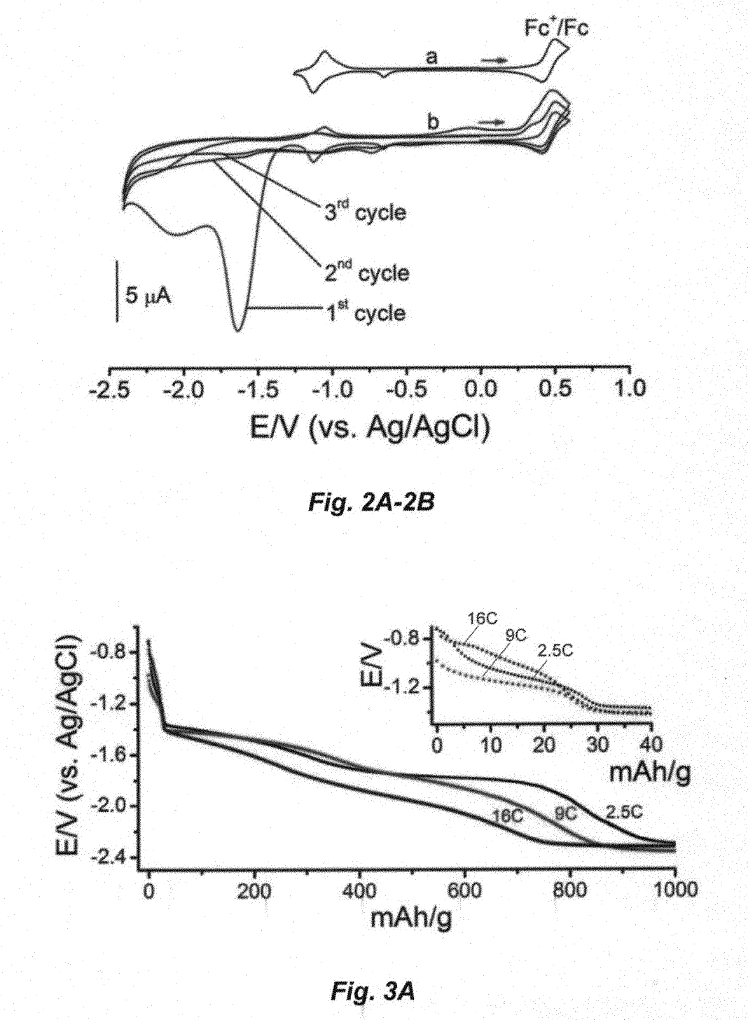

When potential swept to further negative than −1.30 V, two completely irreversible reduction waves with very large current were observed at E_{p/2}=−1.50 V and −1.90 V (vs. Ag/AgCl) (FIG. 2). These two reduction waves are only observable at the first-round potential scan to the negative direction. The corresponding current at the same potential range of the second scan was almost reduced to the baseline. Roughly estimated total charge of these two large reduction waves is about 28 times larger than that of the first reduction wave which corresponds to a single electron transfer reduction of the dibenzophenazine core. These two large reduction peaks were not observed in the control experiments where polymers with same conducting backbone structure and electron transfer catalysts, but without perfluoroalkyl chains, were tested under the same experimental condition. These results clear demonstrate that perflouroalkyl chains in these polymers serves as electron sources for energy storage. Such storage energy was released upon break the C—F bonds by reduction. The most possible reductive defluorination for P-1 is 18 fluorine atoms per polymer unit after the neutral species receives 22 electrons according to the first two reactions in Scheme 2. Even considering the maximum possible error of the current integration, one cannot reasonably conclude that these two large reduction waves solely correspond to the reductive defluorination of the two perfluorobutyl chains and the second reduction of the dibenzophenazine core. This observation is further confirmed with what was observed during chronopotentialmetry experiments (via infra). Given the reductive defluorination product of the perfluoroalkyl chain is polyyne (in the case of M-1 and P-1, the reductive defluorination product is the dibenzophenazine substituted 1,3-diyne derivative), it can reasonably be proposed that the reductive lithiation of the polyynes causes the observed extra electron transfer for the second big reduction wave. This explanation is in line with the observation of multiple reductions and lithiations of polyynes and aromatics. Similar electrochemical behaviors were observed with monomer M-2 and polymer P-2 under the same condition except M-2 has lower solubility than that of M-1 in DFB/TBAPF₆ solution.

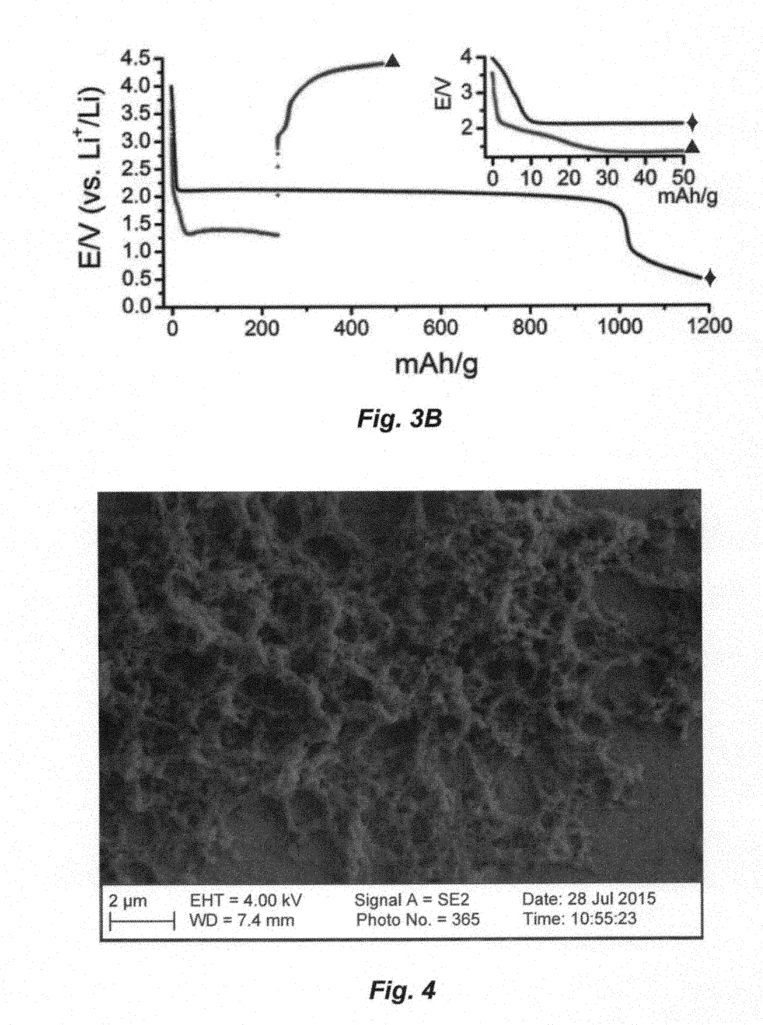

This interesting observation drives us to further investigate the possibility of using these polymers as cathodic materials for battery application. Since the standard redox potentials of Fc⁺/Fc couple is 3.60 V versus Li⁺/Li redox couple, the first irreversible reduction half-peak potential is about 1.64 V versus Li⁺/Li redox couple. Thus, these polymer materials could be used as cathodic materials to assemble a lithium battery with a lithium metal anode with practical working voltage around 1.64 V. To test this hypothesis, a constant current discharge experiment was performed for the P-1 and P-2 in a three-electrode electrochemical system in both DFB/TBAPF₆ and PC/LiPF₆ solutions. To understand the reduction pathway of the polymers, initially the discharge was performed in DFB/TBAPF₆ solution that better wets the polymer film due to the hydrophobic nature (water contact angle 119±4 degree) of the polymer films. FIG. 3A shows constant current discharge E-t curve of P-1 at 2.5 C, 9.0 C, and 16 C discharge rates. At the 2.5 C discharge rate, the first discharge step occurs between −0.70 V and −1.35 V, which corresponds to the first reduction wave in the cyclic voltammogram caused by the one-electron reduction of phenazine core of the polymer lasting for a total of 46 s. The last two discharge steps occur at −1.40 V and −1.75 V which correspond to the reductive defluoronation of the perfluoroalkyl chains and further reduction of the defluorination product, polyynes, lasting for a total of 1390 s, which is 30 times longer than the first step discharge. The total discharge capacity of P-1 polymer is 919 mAh/g. At higher discharge rates, lower discharge capacities and deeper slops were observed as shown in FIG. 3A. However, it was observed that the total specific capacity at the 16 C discharge rate is still well above 700 mAh/g, far higher than reported cathodic materials.

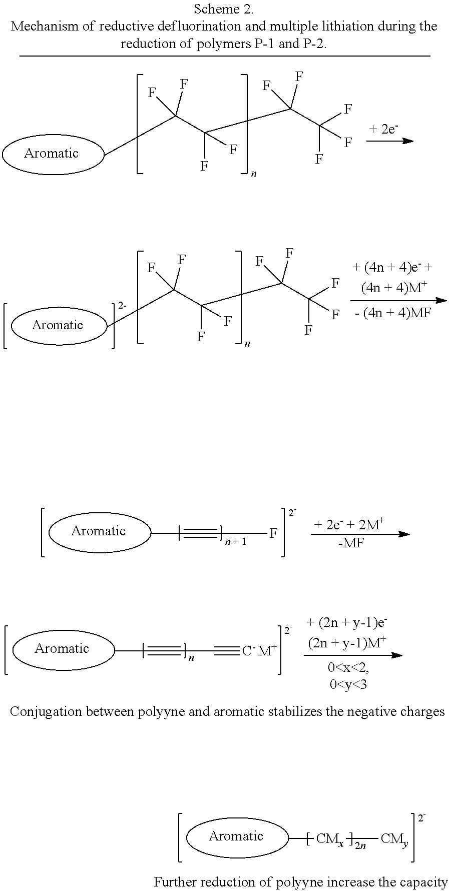

Though many factors could contribute to the capacity change at higher discharge rates, the large kinetic barrier of breaking strong Cₛₚ₃—F bonds is likely one of the key reasons that contributes. However, the reductive defluorination product, polyynes, can conjugate with phenazine aromatic core, stabilizing the entire aromatic system. Furthermore, the strong ion-pair effect of TBAF in DFB/TBAPF₆ solution further drives the reductive defluorination to completion. The promising high rate and high discharge capacity of these perfluoroalkylated polymers prompted us to further test its discharge properties in common electrolyte solutions to evaluate the potential of these polymers being used in lithium batteries. FIG. 3B shows P-1 on GC electrode discharges in PC/1.0 M LiPF₆ solution reaching up specific capacity of 1028 mAh/g with average voltage of 2.1 V (vs. Li⁺/Li) at 0.12 C rate, giving specific energy of 2159 mWh/g under a pre-polarization treatment as shown in FIG. 3B. Without pre-wetting and pre-polarization treatment of P-1 GC electrode in PC/1.0 M LiPF₆ solution, the discharge voltage is only about 1.0 V to 1.4 V with an initial voltage dipping similar to what have been observed with CFₓ materials. This is perhaps due to the hydrophobic nature of the porous polymer film. SEM images (FIG. 4) of the polymer on ITO electrodes show tangled polymer chains with estimated diameters in the range of 50 nm to 100 nm attached onto the electrode surface forming porous materials. This hydrophobic and fluorophilic surface allows better solvation with fluorophilic electrolyte solution like DFB/TBAPF₆, however it provides poor solvation with fluorophobic solution like PC/1.0 M LiPF₆. Searching and optimizing the electrolyte solution for a better interface that facilitates the discharge behavior is currently underway in this laboratory.

In summary, this disclosure provides a new design of high capacity and potentially high rate polymeric cathodic materials integrating electron-conducting polymer, ET catalyst, and energy storage unit perfluoroalkyl chains. In addition to its high capacity, these new cathodic materials are relatively easy and much safer to prepare compared to traditional CFₓ cathodes. The use of this type cathodic material does not require conducting additive and mechanical binding materials to form a usable cathode in practice. Furthermore, in principle, one can synthesize perfluoroalkylated polymeric materials with similar composition, including polypyrrole- and polyanaline-based conducting backbones and various aromatic ET catalysts. Though being able to recharge this cathodic material at relatively low overpotential is still a challenge, oxidative fluorination of polyynes is likely a pathway to proceed. This disclosure provides new light on the field of electrochemical energy storage where discovering new cathodic materials is paramount.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. General Experimental Procedures

All chemicals were purchased from commercial sources and used without further purification unless otherwise specified. All NMR spectra were recorded on a Bruker 400 MHz NMR spectrometer. MS spectra were recorded on a Varian 500-MS mass spectrometer. Melting point was recorded on Vernier MLT-BTA melt station apparatus.

Electrochemical experiments were performed on an Autolab P302N or Autolab P302 potentiostat/galvanostat with NOVA 1.6 software or NOVA 2.0 software. 1,2-Difluorobenzene (DFB) was dried over flame-dried 4 Å molecular sieves using standard Schlenk technique, then stored in a storage flask with additional CaH₂ for at least a week before use. Propylene carbonate was dried with the same procedure as DFB. Both solvents were degassed three times through a standard freeze-pump-throw procedure before being transferred into the nitrogen or argon glovebox. Supporting electrolyte tetrabutylammonium hexafluorophosphate (TBAPF₆) and LiPF₆ was dried under dynamic vacuum at 80° C. for at least three days in a drying pistol or large-mouth vacuum flask and directly brought into nitrogen or argon glovebox for electrochemical experiments. A commercial Pt disk working electrode (Ø1.0 mm) or a commercial glassy-carbon (GC) disk working electrode (01.0 mm), or a homemade GC disk electrode (Ø3.0 mm), or a homemade Al electrode (Ø9.0 mm), a Pt wire or Pt mesh counter electrode, and a homemade Ag/AgCl electrode was used for electrochemical experiments in DFB/TBAPF₆ solution, including regular cyclic voltammetry, electrochemical polymerization, electrochemical characterization of polymer (P-1 or P-2) modified electrode, and constant current discharge/charge experiments of polymer modified electrode in DFB/TBAF6 solution. A polymer (P-1 or P-2) modified Pt or GC working electrode, a large area lithium foil counter electrode, and a lithium foil reference electrode was used in the discharge/charge experiments of polymer (P-1 or P-2) modified GC working electrode in PC/LiPF₆ solution.

### Example 2. Synthesis and Characterization of Monomers M-1 and M-2

Monomers M-1 and M-2 were synthesized according to reaction Scheme 1. Precursor compound 1 was obtained from TCI America and used directly without further purification. Compounds 3a and 3b were synthesized according to earlier reported procedures. Compound 2 was obtained by reducing compound 1 with NaBH₄ according to known procedures.

Monomers M-1 and M-2 were synthesized with a method reported earlier for similar compound perfluoroalkylated dibenzo[a,c]phenazine (Crystal Growth & Design, 2015, 15, 2235).

M-1: A 50 mL round bottom flask was charged with compound 3a (0.15 g, 0.23 mmol) and 3,6-di-2-thienyl-1,2-Benzenediamine 1 (0.07 g, 0.25 mmol), and then suspended onto 12 mL of a 1:3 glacial AcOH/anhydrous EtOH solution. After the solution was stirred for 20 min, the reaction mixture was placed in an oil bath (90° C.) and heated overnight. Once cooled to room temperature a dark red precipitate was filtered. The precipitate was washed with H₂O (3×15 mL), Ethanol (3×15 mL), acetone (10 mL), Chloroform (10 mL), and diethyl ether (20 mL) to afford a red powder in a yield of 0.14 g (70%) with m.p. 243-245° C.; ¹H NMR (400 MHz, CD₂Cl₂) δ (ppm) 9.80 (d, J=8.0 Hz, 2H), 8.86 (s, 2H), 8.40 (s, 2H), 8.13 (d, J=8.0 Hz, 2H), 7.98 (s, 2H), 7.74 (d, J=4.0 Hz, 2H), 7.34 (t, J=4.0 Hz, 2H); ¹⁹F NMR (CD₂Cl₂, 376 MHz); δ −81.26 (t, J=12 Hz, 6F), −110.84 (m, 4F), −122.40 (m, 4F), −125.61 (m, 4F); LC-MS; m/z ((M+H)⁺.) 881.3 (calcd for C₃₆H₁₄F₁₈N₂S₂: 880.03). Anal. Calcd for C₃₆H₁₄F₁₈N₂S₂: C, 49.10; H, 1.60; N, 3.18; found: C, 48.17; H, 1.88; N, 3.01.

M-2: was obtained from compound 3b with the same method of making M-1.

### Example 3. Synthesis of Target Monomers A-1, A-2, and A-3 Shown in Scheme B

As an example, A-1 is synthesized through a condensation reaction involving bisaniline-substituted analine diamine and bisperfluoroalklated phenathrene diketone (Scheme 3) in good yield. For the first step cross coupling reaction: the starting compound was mixed with Pd(PPh₃)₄ and heated for 10 min at 60° C. The boronic acid derivative and 2 M K₂CO₃ (aq), and the solution was heated to 80° C. and stirred for 17 hours. The reaction was quenched with water and the solid was filtered and washed with water. For the second step, the protected aniline derivative was added to NaBH₄ and CoCl₂.6H₂O (catalyst) in EtOH. The solution was refluxed 5 hours and product was collected after quenching the reaction with water. For the third step condensation, perfluoroalkylated diketone was added to the diamine solution of acetic acid and EtOH and refluxed overnight. The solid was filtered and washed with water, acetone, ether and ethanol. The final step, the deprotection step, was completed via the addition of TFA into the reaction mixture and refluxing 2 hours at 95° C. The final product of A-1 was collected after washing with 10% NaHCO₃. ¹H NMR (400 MHz, in CDCl₃, ppm) 9.38 (d, J=8.45 Hz), 8.763 (s); 8.043 (s); 7.974 (d, J=8.89 Hz); 7.825 (d, J=8.29 Hz); 6.986 (d, J=8.28 Hz); 3.91 (s, broad). ¹⁹F NMR (376 MHz, in CDCl₃, ppm): −126.09 (m); −122.68 (m); −121.88 (m); −121.72 (m); −121.40 (m); −121.00 (m); −110.41 (m); −80.74 (m). MS (M+1): 1299.

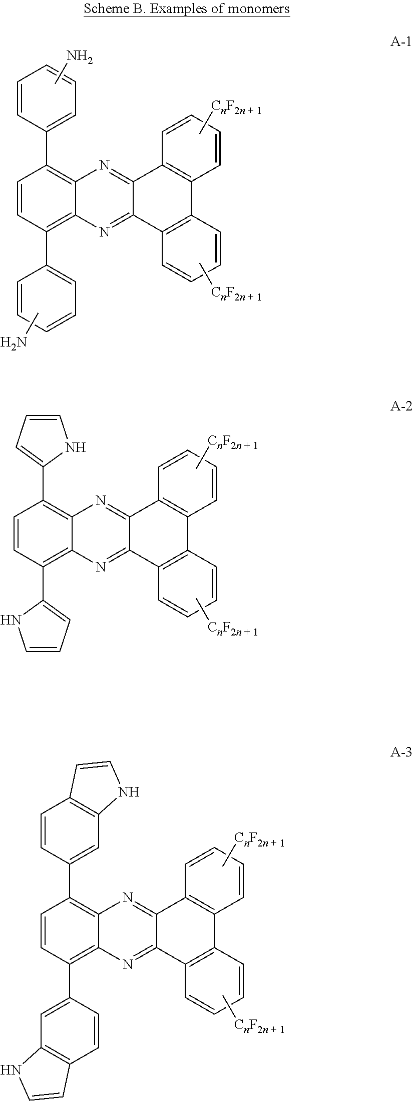

CₙF₂ₙ₊₁, wherein n is integral of 2-1000.
   Similarly, examples of A-2 and A-3 are synthesized through coupling reactions (Scheme 3 and Scheme 4). The corresponding polymers were electrochemically synthesized onto glassy carbon (GC), or tin-doped indium oxide (ITO), or Al working electrodes by repetitive cyclic voltammetry. The polymers were characterized by electrochemical, spectroscopic, and scanning electron microscopic (SEM) methods. A-2 Characterization data: ¹H NMR (400 MHz, in CDCl₃, ppm): 11.62 (s); 8.11 (d, J=8.41 Hz); 8.25 ppm (d, J=8.20 Hz); 8.78 (s); 9.25 ppm (d, J=8.50 Hz); 9.70 ppm (d, J=8.50 Hz), 8.83 (s). ¹⁹F NMR (376 MHz, in CDCl₃, ppm): −126.08 (m); −122.66 (m); −121.85 (m); −121.69 (m); −121.31 (m); −120.95 (m); −110.53 (m); −80.73 (m).

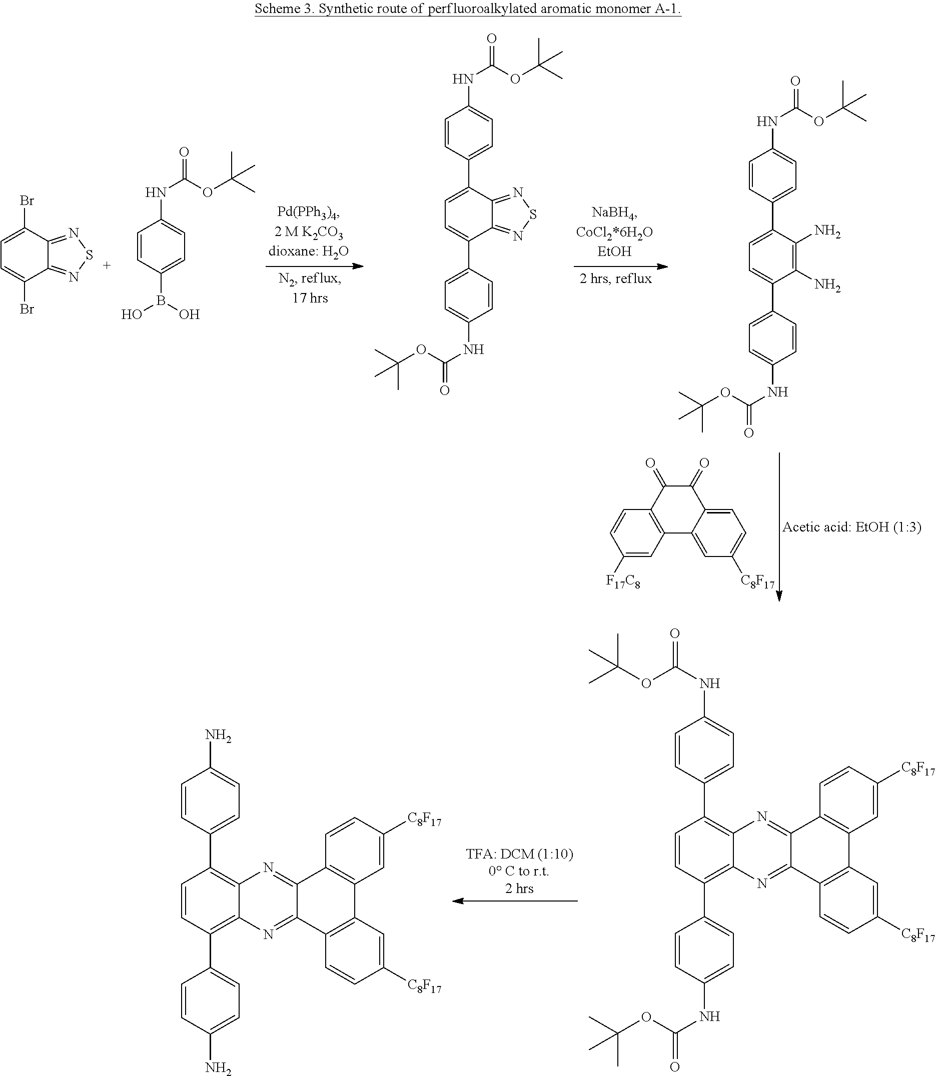

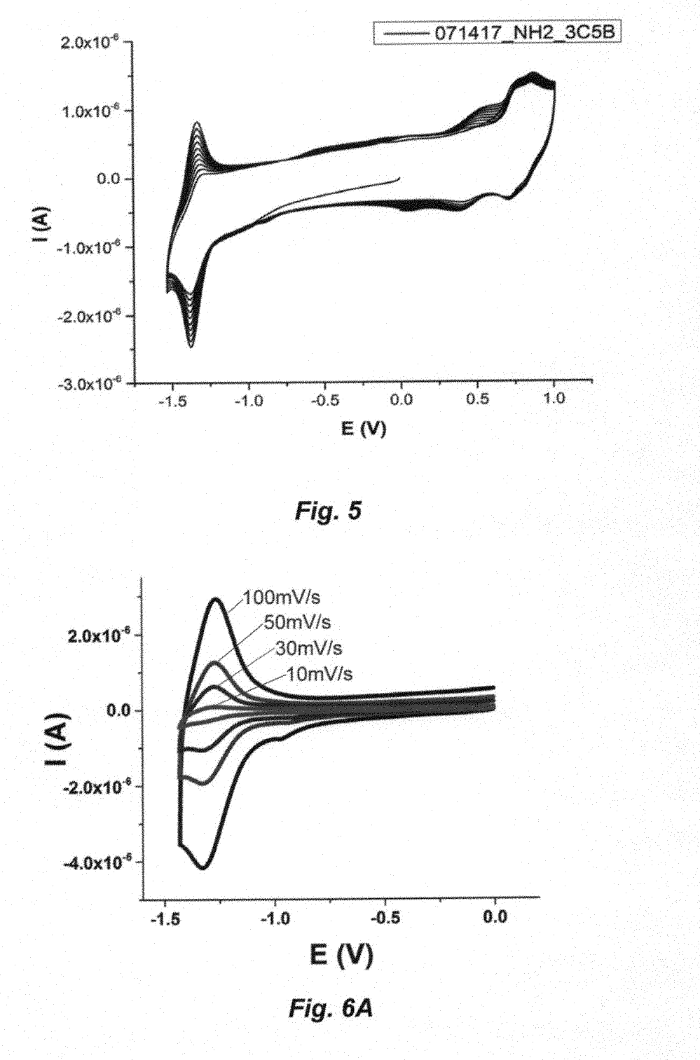

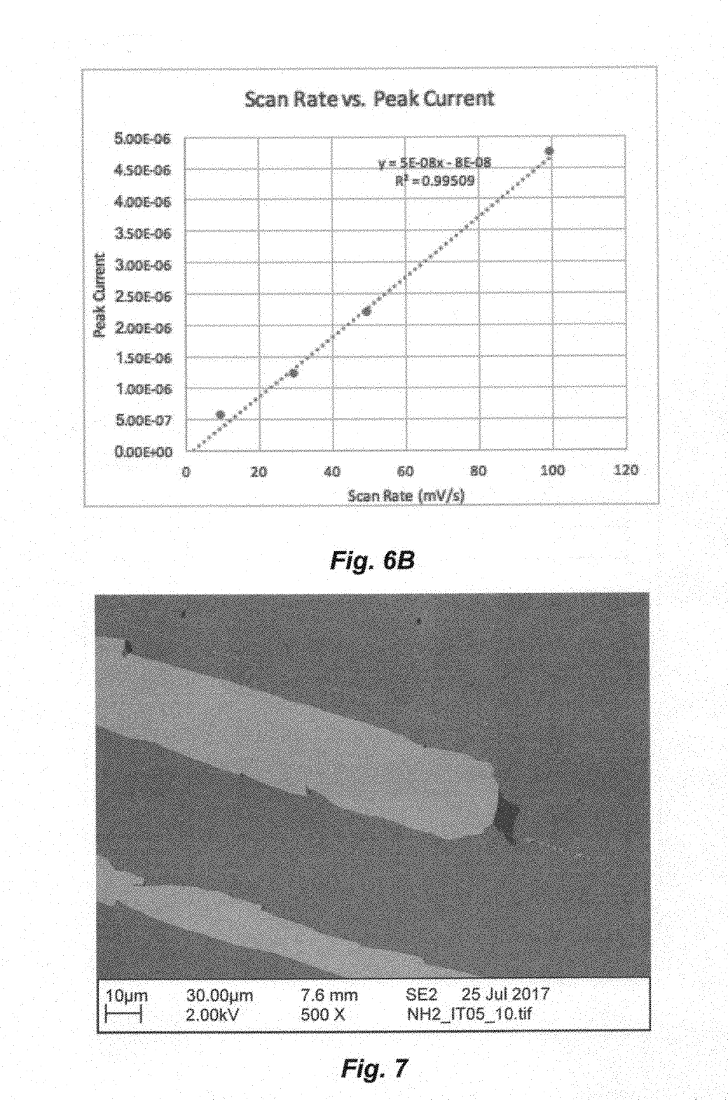

Repetitive potential sweeping between −1.5 V and 1.0 V for A-1 in DFB solution increased both cathodic and anodic currents as shown in FIG. 5, clearly indicating the occurrence of electrochemical polymerization of A-1 on the working electrode surface. The corresponding polymer modified electrode was then placed in a DFB solution with 0.1 M TBAPF₆ as the supporting electrolyte. The polymer exhibits broad oxidation peaks due to the oxidation of the polythiophene backbone and relative sharp reduction wave, which is caused by the reduction of the dibenzophenazine ring. The peak current is linearly proportional to the potential sweep rate which indicates that this is surface redox behavior of a redox-active thin film (FIG. 6).

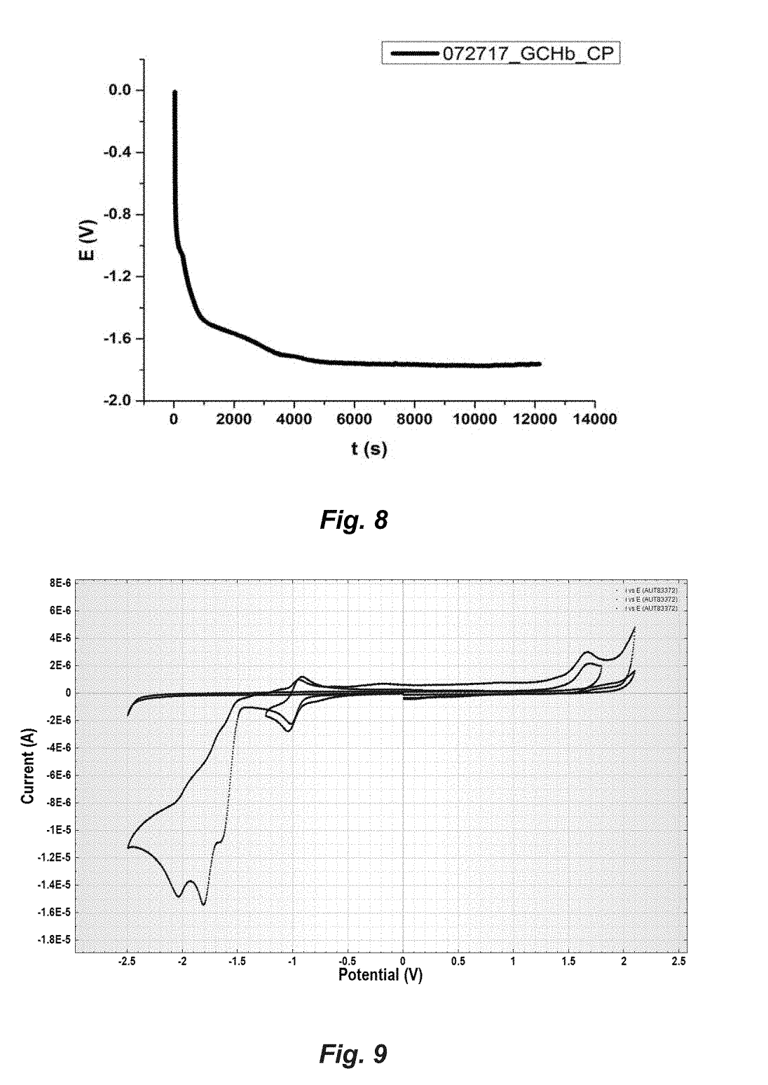

The SEM image (FIG. 7) clearly shows the formation of the polymer film on the electrode surface. The discharge behavior is similar to what was observed in thiophene-containing fluorinated polymers. A typical discharge curve is shown in FIG. 8. The discharge plateau potential is about −1.7 V vs. Ag/AgCl reference electrode, which equivalent of 1.4 V vs. Li+/Li reference electrode. This means that one can use this polymer materials as cathode to assembly a lithium battery with an average voltage of 1.4 V.

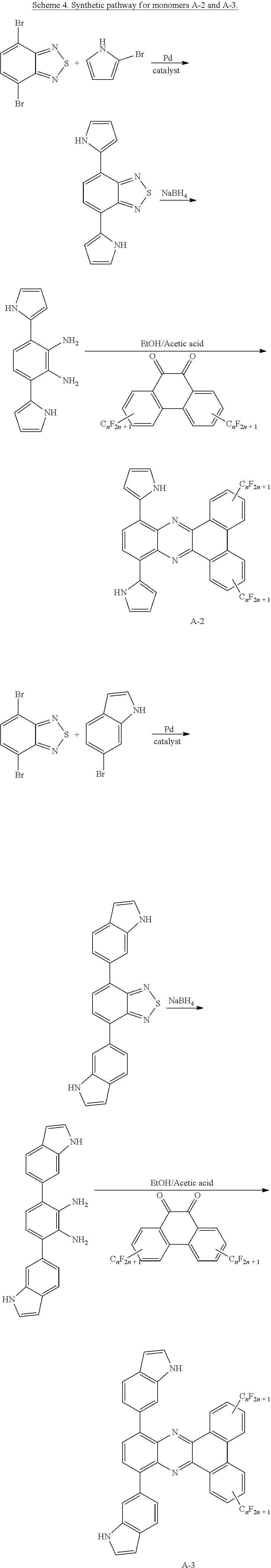

### Example 4. Synthesis and Characterization of Monomer A-4 for Polymer P-3 (Scheme C)

A 50 mL round bottom flask was charged with compound 3,6-bis(perfluorobutyl)-9,10-dione (0.15 g, 0.23 mmol) and 3,6-bis(2-(thienyl) ethynyl)-1,2-Benzenediamine (0.08 g, 0.25 mmol), and then suspended onto 12 mL of a 1:3 glacial AcOH/anhydrous EtOH solution. After the solution was stirred for 20 min, the reaction mixture was placed in an oil bath (90° C.) and heated overnight. Once cooled to room temperature a red precipitate was filtered. The precipitate was washed H₂O (3×15 mL), Ethanol (3×15 mL), acetone (10 mL), Chloroform (10 mL), and diethyl ether (20 mL) to afforded a red powder in a yield of 0.15 g (71%) with m.p. 215-214° C.; ¹H NMR (400 MHz, CD₂Cl₂) δ (ppm) 9.44 (d, 2H), 8.93 (s, 2H), 8.18 (m, 4H), 7.96 (s, 2H), 7.52 (d, 2H), 7.26 (t, 2H); ¹⁹F NMR (CD₂Cl₂, 400 MHz); δ −81.26 (t, J=12 Hz, 6F), −110.84 (m, 4F), −122.40 (m, 4F), −125.61 (m, 4F); LC-MS; m/z (m+.) 931.3 (calcd for C₄₀H₁₄F₁₈N₂S₂: 929.08). Anal. Calcd for C₄₀H₁₄F₁₈N₂S₂: C, 51.73; H, 1.52; N, 3.02; found C, 52.13; H, 1.92; N, 3.92.

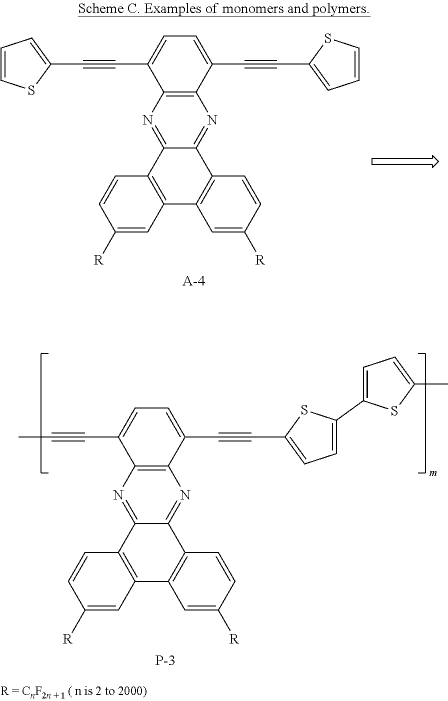

In some embodiments n is 2, 4, 8, 16, etc. In other embodiments, m can be up to 10¹⁵.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A conductive fluoropolymer comprising Formula I: 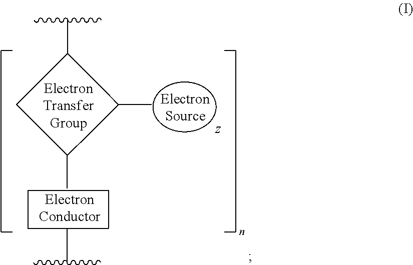
wherein
Electron Source (ES) is a fluorocarbon substituent, or a fluorocarbon substituent comprising a polyene, polyyne, or a polyene and polyyne;
Electron Transfer Group (ET) is an electron withdrawing polycyclic aromatic group covalently bonded to ES, and ET is optionally substituted with one or more electron withdrawing groups;
Electron Conductor (EC) is an electron conducting bisaromatic or trisaromatic moiety conjugated to ET;
n is greater than 1, and Formula I is conjugated to at least one additional Formula I through an EC to ET bond; and
z is 1-20;
wherein the conductive fluoropolymer stores energy in the Electron Source as carbon-fluorine bonds.

2. The conductive fluoropolymer of claim 1 wherein the fluorocarbon substituent is an alkyl, polyvinyl or polyaryl substituent, wherein the alkyl, polyvinyl or polyaryl substituent comprises 2 or more fluorine substituents.

3. The conductive fluoropolymer of claim 2 wherein the fluorocarbon substituent is —CₘF₂ₘ₊₁ and m is greater than zero.

4. The conductive fluoropolymer of claim 1 wherein the polycyclic aromatic group comprises a polyaryl hydrocarbon or a heteroatom-containing polyaryl hydrocarbon.

5. The conductive fluoropolymer of claim 4 wherein the polycyclic aromatic group comprises a pyrene, naphthalene, anthracene, coronene, phenazine, phenanthroline, phthalocyanine, quinoxaline, quinoline, porphyrin, benzoporphyrin, quinazoline, benzofuran, indole, benzoxazole, or benzimidazole.

6. The conductive fluoropolymer of claim 4 wherein the polycyclic aromatic group is substituted with one or more electron withdrawing groups.

7. The conductive fluoropolymer of claim 6 wherein the electron withdrawing group is halo, cyano, nitro, carboxyl, sulfonyl, phosphoryl, aryl, pyridine, or pyridine N-oxide.

8. The conductive fluoropolymer of claim 4 wherein the heteroatom-containing polyaryl hydrocarbon is a transition metal complex.

9. The conductive fluoropolymer of claim 8 wherein the transition metal complex is a metallophthalocyanine, metalloporphyrin, or metallobenzoporphyrin.

10. The conductive fluoropolymer of claim 1 wherein ET has a first reduction potential equal to about 0.5 V or above about 0.5 V versus a Li⁺/Li electrode and a first oxidation potential equal to about 6 V or less than about 6 V versus the Li⁺/Li electrode.

11. The conductive fluoropolymer of claim 1 wherein the bisaromatic or trisaromatic moiety comprises a thiophene, pyrrole, aniline, or a combination thereof, wherein said moieties have optional substituents.

12. The conductive fluoropolymer of claim 1 wherein Formula I is Formula II: 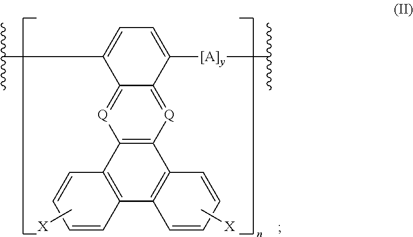
wherein
each X is independently a fluorocarbon, or a fluorocarbon comprising a polyene, polyyne, or both;
each Q is independently CR¹ or N, wherein each R¹ is independently H, halo, CN, NO₂, COR², or SO₂R², and each R² is independently H, OH, alkoxy, or alkyl;
each A is independently thiophene, pyrrole, aniline, benzothiophene, or indole;
y is 2, 3, or 4; and
n is >20.

13. The conductive fluoropolymer of claim 12 wherein X is —CₘF₂ₘ₊₁ and m is greater than zero.

14. The conductive fluoropolymer of claim 12 wherein Formula II is Formula III:

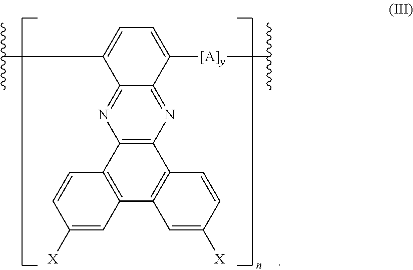

15. The conductive fluoropolymer of claim 14 wherein Formula III is one of Formulas IV-VI: 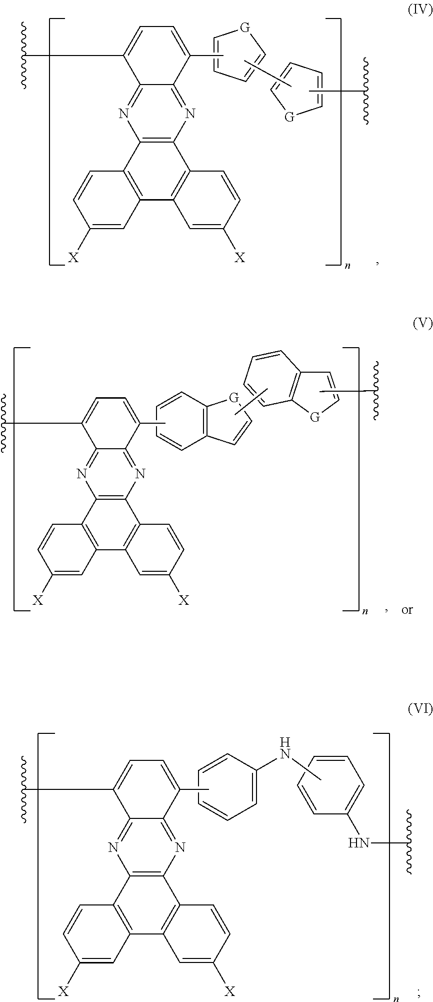
wherein
each G is independently S or NH.

16. The conductive fluoropolymer of claim 15 wherein Formula IV is Formula VII:

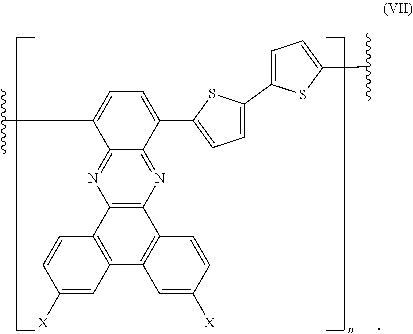

17. A cathode coated with the conductive fluoropolymer of claim 1, wherein the energy in the carbon-fluorine bonds of the Electron Source is capable of being released as electrons to the Electron Transfer Group wherein the electrons are transmitted to a current collector by the Electron Conductor from the coated cathode.

18. A method of producing electrochemical energy from a high capacity electrochemical cell, comprising:
discharging a high capacity electrochemical cell wherein fluoride is released from a conductive fluoropolymer of claim 1 thereby producing electrochemical energy, and wherein the high capacity electrochemical cell comprises:
a) a positive electrode coated with the conductive fluoropolymer;
b) a negative electrode hosting an alkali metal or alloy of alkali metals; and
c) an ion porous membrane disposed between the positive and negative electrode;
wherein the positive and negative electrodes and the membrane are immersed in an electrolyte.

19. The method of claim 18 wherein the positive electrode or a cathode coated with the conductive fluoropolymer has a specific capacity of at least about 500 mAh/g at about 2.5 C.

20. The method of claim 19 wherein a prepolarizing step of the positive electrode or the cathode increases the specific capacity.

21. The method of claim 20 wherein the specific capacity increases to at least about 1000 mAh/g.
